(19) United States
(12) Patent Application Publication
(10) Pub. No.: US 2005/0009389 A1
(43) Pub. Date: Jan. 13, 2005

(54) Eject mechanism for memory card connector

(76) Inventor: Chia-Chen Chang, Hsin Chung City (TW)

Correspondence Address: MOLEX INCORPORATED, 2222 WELLINGTON COURT, LISLE, IL, 60532, US

(21) Appl. No.: 10/869,543

(22) Filed: Jun. 16, 2004

(30) Foreign Application Priority Data
Jun. 17, 2003 (TW) 92211044

(51) Int. Cl. H01R 13/62

(52) U.S. Cl. 439/159

(57) ABSTRACT

A memory card connector includes an insulative housing which at least in part defines a card-receiving space for the insertion thereinto of a memory card. A card eject mechanism is mounted on the housing and includes a slide member movable with the memory card in an insertion/ejection direction. The housing has a guide track and the slide member has a track follower to guide and stabilize the movement of the slide member in the insertion/ejection direction.

### FIELD OF THE INVENTION

This invention generally relates to the art of electrical connectors and, particularly, to an improved eject mechanism for a memory card connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

A typical memory card connector includes some form of dielectric housing which is covered by a metal shell. The metal shell may be stamped and formed of sheet metal material and formed substantially into a box-shape. The metal shell and the housing combine to define a card-receiving cavity. One end of the cavity is open to form a card-insertion opening. The dielectric housing may be generally L-shaped or U-shaped and includes a rear terminal-mounting section at the rear of the cavity, and a longitudinal side wall section extends forwardly from one or both ends of the rear section at one or both sides of the cavity. The contacts or terminals of the connector are mounted on the rear section. The metal shell has a top plate substantially covering the dielectric housing, with side plates extending downwardly over the side wall sections of the housing. The side plates of the metal shell and/or the side wall sections of the housing define the sides of the card-receiving cavity.

The memory card connector often is mounted on the top surface of a printed circuit board, and solder tail portions of the terminals are connected, as by a reflow soldering process, to appropriate circuit traces on the board. The connector often includes some form of eject mechanism to facilitate ejecting a memory card from the card-receiving cavity of the housing. The eject mechanism often is mounted on one of the side wall sections of the L-shaped or U-shaped housing.

FIGS. 1 and 2 show a typical memory card connector, generally designated 12, according to the prior art. The connector includes an insulative housing, generally designated 14, having a rear terminal-mounting section 16 and a pair of side wall sections 18 and 20 extending forwardly from opposite ends of the rear section and defining a card-receiving space 22 for insertion thereinto of a memory card in the direction of arrow “A”. A plurality of conductive terminals, generally designated 24, are mounted through rear section 16 of the housing. The terminals have contact arms 24a projecting forwardly into the card-receiving space for engaging appropriate contacts on the memory card. The connector is adapted for mounting on a printed circuit board, and terminals 24 have tail portions 24b for connection, as by soldering to appropriate circuit traces on the printed circuit board. An inverted U-shaped metal cover, generally designated 26, is mounted over the top of the housing and has a top plate 26a spanning the card-receiving space 22 as seen in FIG. 2.

Connector 12 includes a card eject mechanism, generally designated 28, mounted on side wall section 18 of the housing. The eject mechanism includes a slide member, generally designated 30. The slide member includes a body portion 32a which slides within a passage 32 in side wall section 18. The slide member has a card-engaging portion 30b which engages one corner of the memory card as the memory card is inserted into the connector and ejected therefrom.

Problems are encountered with eject mechanisms of the prior art as described above in relation to FIGS. 1 and 2. Specifically, it can be seen that slide member 30, particularly the card-engaging portion 30b, engages only one side or corner of the memory card. Therefore, uneven forces are applied to the card during an ejection operation, and the reaction forces from the card to slide member 30 causes the slide member to “cock” or twist within passage 32. As a result, the slide member, as well as passage 32 in side wall section 18, become worn during repeated operations. Continued wearing results in increased deterioration between the parts whereafter the memory card, itself, can twist within card-receiving space 22 and cause additional, unnecessary wearing of other parts of the connector. As seen FIG. 1, the top surface of body portion 32a of the slide member is smooth. As seen in FIG. 2, the bottom surface and the inside surface of the body portion of the slide member also are smooth. Therefore, the slide member can loosely move within passage 32 and facilitate the wearing problem. The present invention is directed to solving these problems.

### SUMMARY OF THE INVENTION

An object, therefore, of the invention is to provide a new and improved eject mechanism for a memory card connector.

In the exemplary embodiment of the invention, a memory card connector includes an insulative housing which at least in part defines a card-receiving space for the insertion thereinto of a memory card. A card eject mechanism is mounted on the housing and includes a slide member movable with the memory card in an insertion/ejection direction. Complementary interengaging guide track and track follower means are provided between the slide member and the housing to guide and stabilize the movement of the slide member in the insertion/ejection direction.

According to one aspect of the invention, the slide member is slidably mounted in an elongated passage in the housing extending in the insertion/ejection direction. The guide track and track follower means are located in the passage. In the preferred embodiment, the elongated passage includes a floor, and the guide track and track follower means are located between the floor of the passage and a bottom surface of the slide member.

According to another aspect of the invention, the housing includes a guide track extending in the insertion/ejection direction and engageable with a track follower on the slide member. In the preferred embodiment, the guide track is provided by an elongated guide rib on the housing embraced by a guide groove on the slide member. Both the guide rib and the guide groove are elongated in the insertion/ejection direction.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective of a memory card connector according to the prior art and as described in the Background, above;

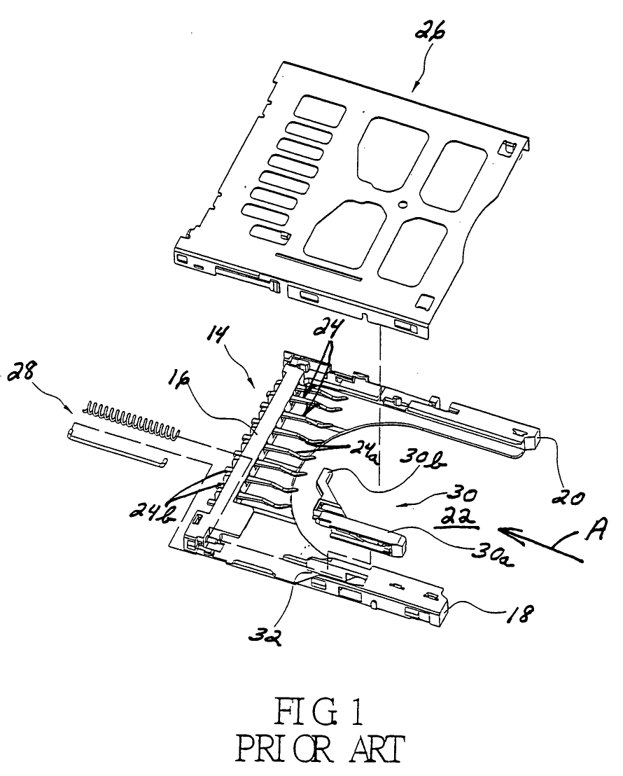

FIG. 2 is a perspective view similar to that of FIG. 1, but with the slide member of the prior art connector turned upside-down to show its bottom and inside surfaces;

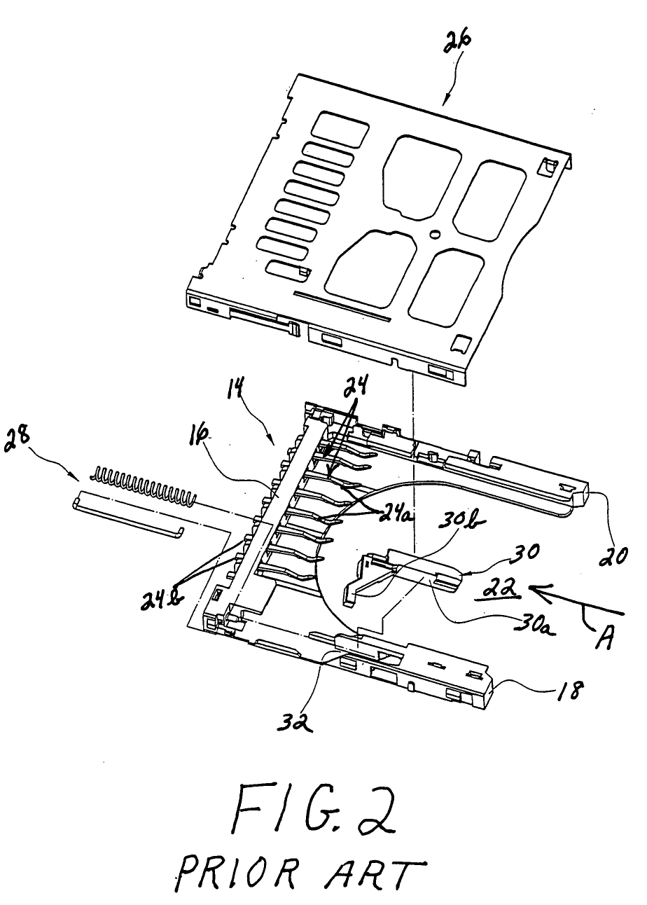

FIG. 3 is an exploded perspective view of a first embodiment of a memory card connector according to the invention;

FIG. 4 is a perspective view similar to that of FIG. 3, with the slide member turned upside-down to show the track follower groove in the bottom surface thereof;

FIG. 5 is an exploded perspective view of a memory card connector according to a second embodiment of the invention;

FIG. 6 is a perspective view of the connector in FIG. 5, in assembled condition;

FIG. 7 is an exploded perspective view of a memory card connector according to a third embodiment of the invention;

FIG. 8 is a perspective view of the connector in FIG. 7, in assembled condition;

FIG. 9 is an exploded perspective view of a memory card connector according to a fourth embodiment of the invention;

FIG. 10 is a perspective view of the connector in FIG. 9, in assembled condition; and

FIG. 11 is a perspective view of a memory card connector according to a fifth embodiment of the invention, in assembled condition.

### DETAILED DESCRIPTION OF THE PREFERRED EMBODIMENTS

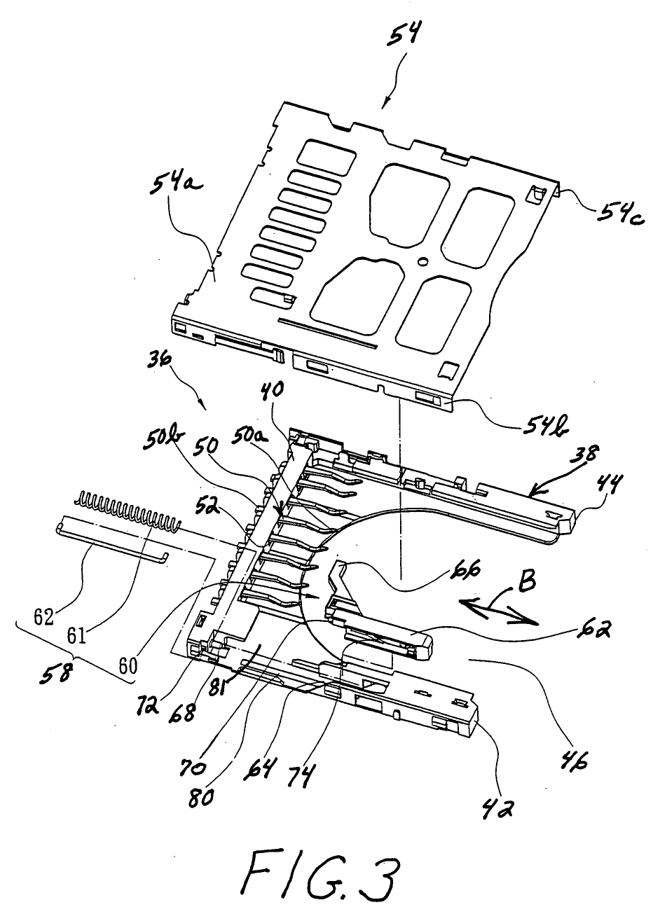

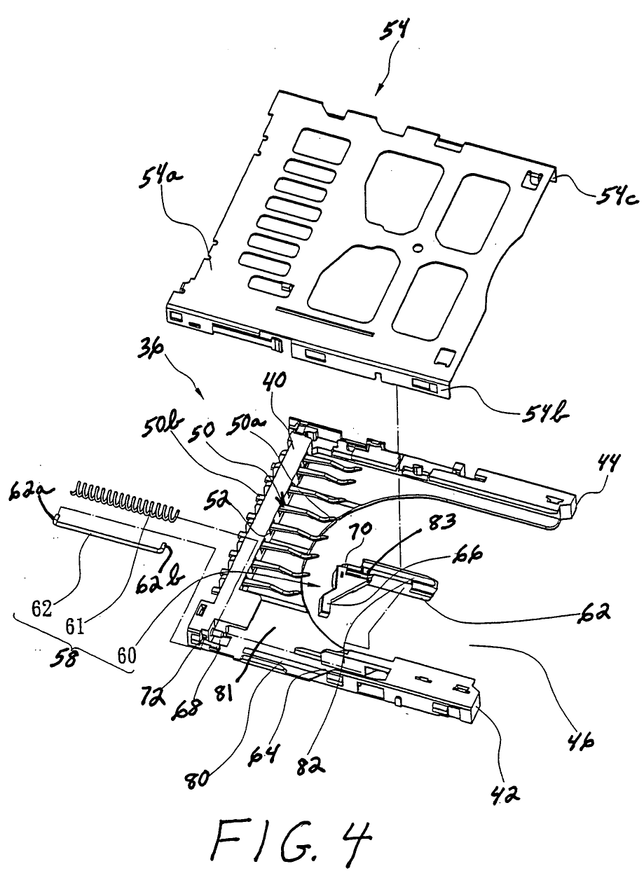

Referring to the drawings in greater detail, and first to FIGS. 3 and 4, a first embodiment of the invention is shown in a memory card connector, generally designated 36. The connector includes an insulative housing, generally designated 38, having a rear terminal-mounting section 40. A pair of side wall sections 42 and 44 project forwardly from opposite ends of the rear section and define a card-receiving space 46 between the side wall sections and in front of the rear section.

A plurality of terminals, generally designated 50, are mounted within a corresponding plurality of passages 52 in rear section 40 of the housing. The terminals have elongated contact arms 50a cantilevered forwardly into card-receiving space 46 for engaging appropriate contacts on a memory card inserted and ejected into and out of the card-receiving space in an insertion/ejection direction indicated by double-headed arrow “B” (FIG. 4). Housing 38 is adapted for mounting on top of a printed circuit board, and terminals 50 have tail portions 50b for connection, as by soldering, to appropriate circuit traces on the printed circuit board.

A cover, generally designated 54, is mounted over housing 38 as shown in FIG. 4. The cover is stamped and formed of sheet metal material to provide a shield over the connector. The cover has an inverted U-shaped configuration as defined by a top plate 54a and a pair of depending side plates 54b and 54c. When the cover is mounted onto housing 38, side plates 54b and 54c of the cover overlap the outsides of side wall sections 42 and 44, respectively, of the housing, while top plate 54a of the cover spans the top of card-receiving space 46. The cover has a plurality of latch openings 54d which “snap” into latching engagement with a plurality of chamfered latch bosses 56 projecting slightly form the outside surfaces of the side wall sections of the housing. This securely latches the cover over the housing as shown in FIG. 4.

Connector 36 includes a card eject mechanism 58 which includes a slide member, generally designated 60, a coil spring 61 and a cam follower rod 62. Slide member 60 includes an elongated body portion 62 slidably mounted within a guide passage 64 in side wall section 42 of the housing. An eject arm 66 projects inwardly from the rear end of body portion 62 for engaging a corner of a memory card. One end of coil spring 61 is positioned over a post 68 on the housing at the rear of guide passage 64, and the opposite end of the spring is positioned over a post 70 at the rear of elongated body portion 62 of the slide member. Therefore, the coil spring is sandwiched between the housing and the slide member to bias the slide member forwardly in an ejection direction.

Eject mechanism 58 is of the “push/push” type which is well known in the art. Suffice it to say, cam follower rod 62 is generally U-shaped and has a rear end 62a which is fixedly positioned within a hole 72 at one end of rear section 40 of the housing. An opposite end 62b comprises a cam follower which rides in a heart-shaped cam groove 74 in the outside face of body portion 62 of slide member 60. In operation, a memory card is inserted into card-receiving space 46 into engagement with the slide member to push the slide member to a rear position whereat cam follower 62b rides into a particular position of cam groove 74 to latch the slide member and the memory card in its fully inserted position. A second “push” on the memory card releases cam follower 62b from its latched position within cam groove 74 to allow coil spring 61 to push the slide member outwardly and eject the memory card.

Generally, the invention contemplates the provision of complementary interengaging guide track and track follower means between slide member 60 and cover 54 to guide and stabilize the movement of the slide member (thereby the memory card) in the insertion/ejection direction [symbol] B [symbol] (FIG. 3). Specifically, the first embodiment of the invention shown in FIGS. 3 and 4 includes a guide rib 80 which extends longitudinally of side wall section 42 at the bottom of guide passage 64. The guide passage includes a floor 81 along which guide rib 80 extends and from which the guide rib projects. Correspondingly, an elongated guide groove 82 (FIG. 4) is formed in a bottom surface 83 of body portion 62 of slide member 60. In essence, the second embodiment includes complementary interengaging guide track 80 and track follower means 82 between the side wall section 42 of housing 38 and slide member 60 to stabilize the movement of the slide member in the insertion/ejection direction “B”.

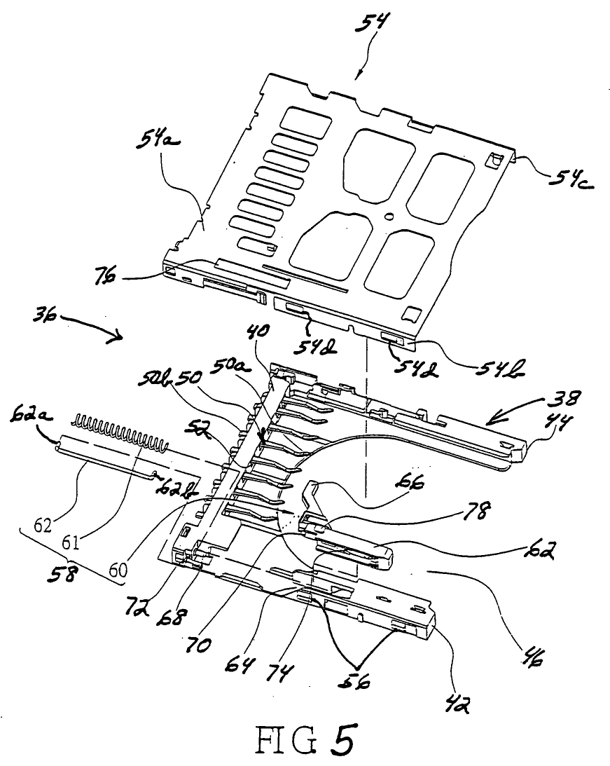

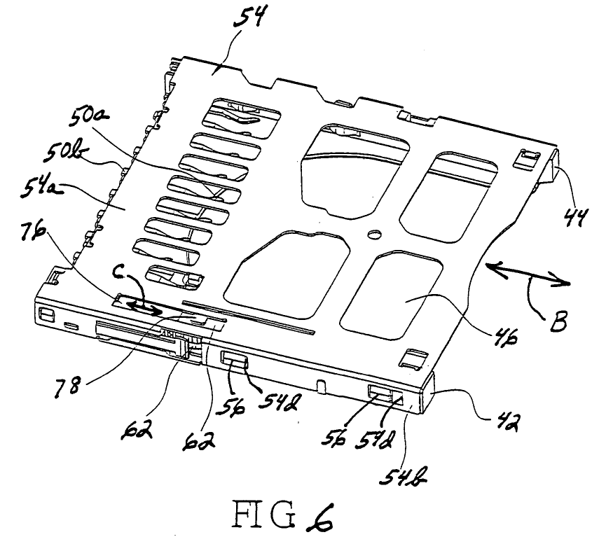

FIGS. 5 and 6 show a second embodiment of the invention. At this point, it should be understood that like reference numerals have been applied to like components throughout of the embodiments of the invention in all of the FIGS. 5-11, corresponding to like components described above in relation to the first embodiment of FIGS. 3 and 4. In addition, the description, operation and/or function of those like components will not be repeated from the descriptions already set forth in relation to FIGS. 3 and 4.

With that understanding, the second embodiment of FIGS. 5 and 6 include the provision of a guide track 76 in top plate 54a of cover 54 engageable with a track follower 78 on slide member 60. Guide track 76 is formed by a slot in the top plate of the cover, the slot being elongated in the insertion/ejection direction “B”. Track follower 78 comprises a follower protrusion projecting upwardly from the top surface of body portion 62 of the slide member. As seen in FIG. 4, follower protrusion 78 projects upwardly into guide slot 76 and moves therewithin in the direction of double-headed arrow “C”. This guide track and track follower mechanism guides and stabilizes the movement of the slide member, prevents the slide member from “cocking” or twisting and, thereby, reduces wear and increases the life of the connector.

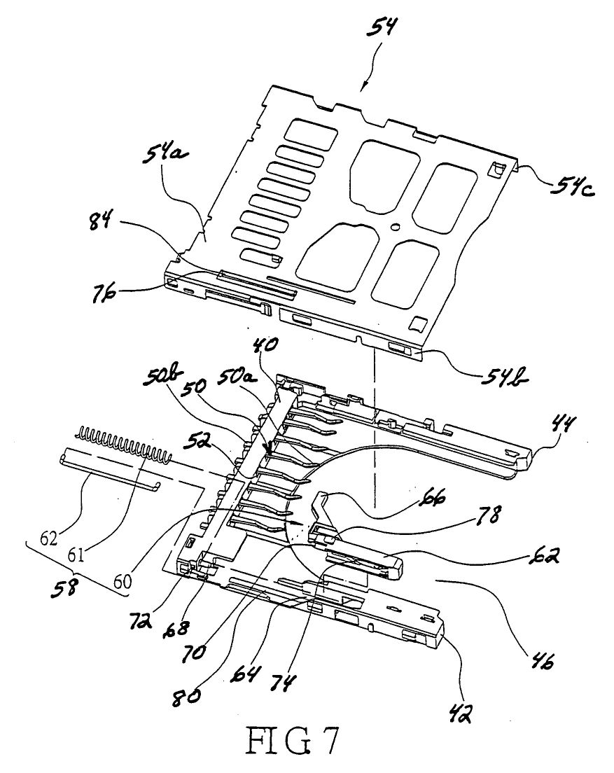

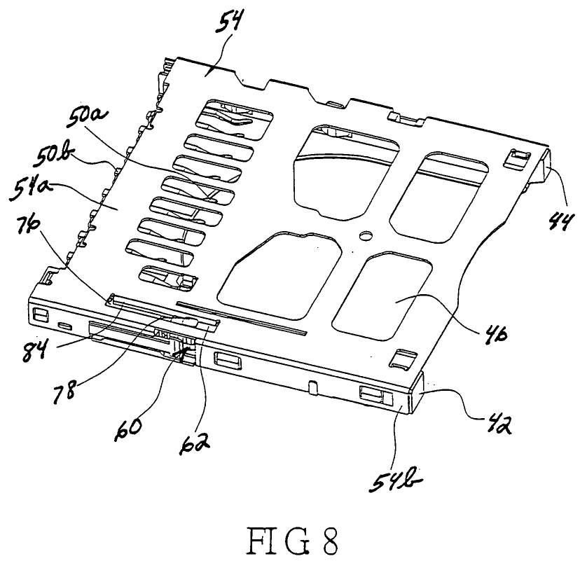

FIGS. 7 and 8 show a third embodiment of the invention which includes an elongated guide flange 84 which extends in the insertion/ejection direction and engages the inner side wall of elongated body portion 62 during movement of slide member 60. In the preferred embodiment, and with cover 54 stamped and formed of sheet metal material, guide flange 84 can be conveniently stamped out of guide slot 76 and formed downwardly from top plate 54a of the cover, whereby the elongated guide flange runs along the edge of guide slot 76 at one side thereof. The guide flange further stabilizes the movement of slide member 60.

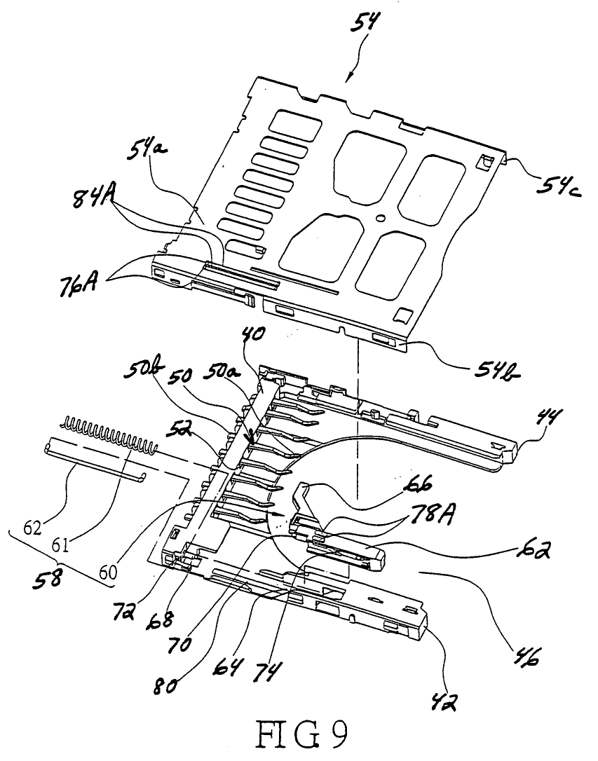

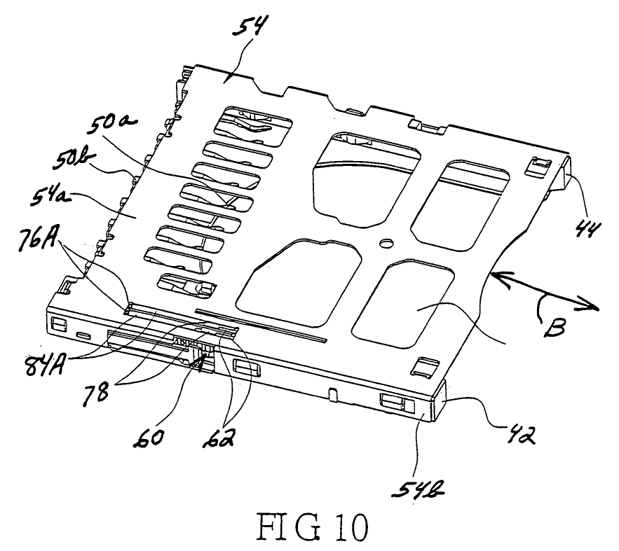

FIGS. 9 and 10 show a fourth embodiment of the invention wherein a pair of elongated, generally parallel guide slots 76A are formed in top plate 54a of cover 54. Correspondingly, a pair of follower protrusions 78A project upwardly from body portion 62 of slide member 60. The two protrusions slidably move within the two guide slots to guide and stabilize the movement of the slide member. In addition, a pair of elongated guide flanges 84A may be stamped and formed downwardly out of guide slots 76A the same as guide flange 84 described above in relation to third embodiment of FIGS. 7 and 8.

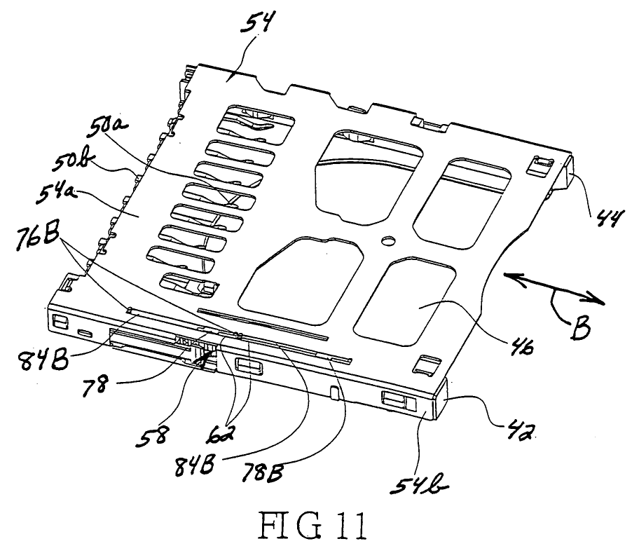

Finally, FIG. 11 shows a fifth embodiment of the invention wherein a pair of guide tracks 76B are formed in top plate 54a of cover 54. Rather than being parallel as in the fourth embodiment of FIGS. 9 and 10, guide tracks 76B in FIG. 11 are mutually aligned in the insertion/ejection direction “B”. Correspondingly, a pair of follower protrusions 78B project upwardly from the top of body portion 62 of the slide member and into guide slots 76B. Again, a pair of elongated guide flanges 84B are stamped and formed out of guide slots 76B and run along the edges of the slots at one side thereof. Although FIG. 11 shows two guide slots 76B in mutual alignment in the direction of double-headed arrow “B”, it should be understood that a single elongated slot is contemplated for receiving both of the mutually aligned follower protrusions 78B. The two slots simply have sturdier side walls than a single, longer slot.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector, comprising:
an insulative housing which at least in part defines a card-receiving space for the insertion thereinto of a memory card;
a card eject mechanism mounted on the housing and including a slide member movable with the memory card in an insertion/ejection direction; and
complementary interengaging guide track and track follower means between the slide member and the housing to guide and stabilize the movement of the slide member in said insertion/ejection direction.

2. The memory card connector of claim 1 wherein said housing includes a guide track extending in said insertion/ejection direction and engageable with a track follower on the slide member.

3. The memory card connector of claim 2 wherein said guide track comprises a guide rib on the housing embraced by a guide groove on the slide member.

4. The memory card connector of claim 3 wherein said guide rib is elongated in said insertion/ejection direction.

5. The memory card connector of claim 4 wherein said guide groove is elongated in said insertion/ejection direction.

6. The memory card connector of claim 1 wherein said slide member is slidably mounted in an elongated passage in the housing extending in said insertion/ejection direction, and said guide track and track follower means are located in the passage.

7. The memory card connector of claim 1 wherein said elongated passage includes a floor, and said guide track and track follower means are located between the floor of the passage and a bottom surface of the slide member.

8. A memory card connector, comprising:
an insulative housing which at least in part defines a card-receiving space for the insertion thereinto of a memory card in an insertion/ejection direction, the housing including an elongated passage extending in said insertion/ejection direction;
a card eject mechanism mounted on the housing and including a slide member slidably mounted in the elongated passage in the housing; and
complementary interengaging guide track and track follower means between the slide member and the housing within said elongated passage to guide and stabilize the movement of the slide member in said insertion/ejection direction.

9. The memory card connector of claim 8 wherein said housing includes a guide track in said passage extending in said insertion/ejection direction and engageable with a track follower on the slide member.

10. The memory card connector of claim 9 wherein said guide track comprises a guide rib on the housing embraced by a guide groove on the slide member.

11. The memory card connector of claim 10 wherein said elongated passage includes a floor, and said guide rib is located on the floor and the guide groove is located in a bottom surface of the slide member.

12. The memory card connector of claim 11 wherein said guide rib is elongated in said insertion/ejection direction.

13. The memory card connector of claim 12 wherein said guide groove is elongated in said insertion/ejection direction.

14. The memory card connector of claim 8 wherein said elongated passage includes a floor, and said guide track and track follower means are located between the floor of the passage and a bottom surface of the slide member.
